(19) United States
(12) Patent Application Publication
(10) Pub. No.: US 2018/0356379 A1
(43) Pub. Date: Dec. 13, 2018

(54) NON-REVERSIBLE HUMIDITY INDICATOR CARD

(71) Applicant: Clariant Corporation, Louisville, KY (US)

(72) Inventors: Robert D. DiMaggio, Riverside, CA (US); Mark Reese, Rancho Cucamonga, CA (US)

(21) Appl. No.: 15/986,909

(22) Filed: May 23, 2018

Related U.S. Application Data
(60) Provisional application No. 62/517,229, filed on Jun. 9, 2017.

(51) Int. Cl. G01N 31/22

(52) U.S. Cl. CPC G01N 31/222

(57) ABSTRACT

The present invention is directed to methods for preparing and using a substrate having a deliquescent-containing area for a non-reversible humidity indicator card. Embodiments provided herein also are directed to formulations that are utilized with such cards, as well as the approach of dispensing a composition with a deliquescent material in solution upon a card that can be used as a non-reversible humidity indicator.

### CROSS-REFERENCE TO RELATED APPLICATIONS

This application claims priority to U.S. Provisional Patent Application Ser. No. 62/517,229 filed Jun. 9, 2017, which is incorporated herein by reference in its entirety.

### FIELD OF INVENTION

Current embodiments relate to the protection of articles of commerce from the harmful effects of ambient humidity by providing a composition containing a deliquescent material in solution. The composition is dispensed onto a card or other substrate to serve as a humidity indicator that detects when humidity has exceeded a predetermined threshold inside a container, a warehouse, or otherwise in the environment surrounding such articles. The solution of deliquescent material is added to a predetermined area of the card and is sensitive to ambient humidity, expressed as relative humidity, so that a detectable change occurs when a certain threshold humidity is reached or exceeded for a sufficient period of time. Such change is perceptible to human vision or can be sensed by a machine optical reader.

### BACKGROUND

Many articles of commerce are shipped or stored in containers. Over a period of time, moisture existing as water vapor (i.e., humidity) in the surrounding environment makes the articles prone to corrosion, degradation, or other damage. Semiconductors provide one such example, because semiconductors vary in their Moisture Sensitivity Level (“MSL”). For some semiconductors, upon exposure to as little as 10% relative humidity (“RH”) for a sufficient period of time, they will require re-baking to mitigate the effects of exposure to RH before being soldered onto a printed circuit board. Other semiconductors have a higher MSL, so they can withstand a higher threshold of RH before they are severely damaged or otherwise have to undergo mitigating steps such as re-baking.

Printed circuit boards, semiconductors, and other electronic components are not the only articles prone to damage. Food commodities, pharmaceutical products, industrial products, and laboratory testing kits, to name a few, are among the kinds of articles that spend a great deal of time enclosed in a container as part of commercial transit or long term storage in either a humidity-controlled or uncontrolled environment, where they are exposed to ambient humidity. Further, humidity often carries microscopic dust or other particles that can damage such articles. Accordingly, a number of approaches have been used for detecting and otherwise controlling humidity that could damage such articles.

Such approaches have included the use of humidity indicators placed in the same environment as the articles. Humidity indicators provide an observable sign that can be sensed by a human or machine that the environment surrounding the article reached a predetermined humidity level. Some uses have employed reversible humidity indicators. However, problems with reversible humidity indicators have been noted in that, during the time when such articles are within a container, the ambient humidity may fluctuate between high and low. Consequently, with a reversible humidity indicator, an intermittent high humidity might damage the articles, even though the signs of such a condition might disappear as humidity drops. This could prevent the user from knowing if the card (and contents of the container) have been exposed to RH conditions above a particular threshold. Thus, a number of non-reversible humidity indicators have been used instead of the reversible kind.

Whether reversible or non-reversible, some prior humidity indicators have operated based on deliquescence, i.e., the tendency of solid, crystalline material to absorb and dissolve in the surrounding moisture from the air. Deliquescent materials can be particulate. Generally, such materials dissolve at a specific RH, which may vary slightly depending on temperature or other environmental factors. Lithium chloride, magnesium chloride, calcium chloride, sodium bromide, potassium acetate, magnesium nitrate, sugar, nickel nitrate, ferric nitrate, cobalt bromide, ammonium nitrate, sodium dichromate, ferrous chloride, ammonium dichromate, nickel chloride, strontium chloride, cuprous chloride, cuprous nitrate, potassium carbonate, and sodium carbonate are non-limiting examples of deliquescent materials—both inorganic and organic—which have been identified for use with humidity indicators.

In some of the prior humidity indicators, the deliquescent material dissolves until the point of saturation, which is where the vapor pressure of air moisture equilibrates with the water vapor pressure of the solution containing the deliquescent material. This tendency results in variability in the relative humidity at which deliquescence occurs from one material to another.

Some prior humidity indicators have placed the deliquescent material into a housing, a porous matrix, or other carrier for placement in or on a container. Some prior humidity indicators have provided a visual indication of when the deliquescent material has absorbed a threshold amount of humidity. Some have been arranged such that as the deliquescent material dissolves and changes from solid to liquid, the liquid migrates within the housing or carrier to cause an alteration in color, a change in optical properties, or other effect capable of being sensed. In some prior humidity indicators, a liquid may be carried from one position in the housing to another along a wick to provide such visual effects.

Some prior humidity indicators have employed chromogenic materials that change color when exposed to the migrating solution, providing an observable change to detect the presence of humidity. Such an approach requires two different delivery mechanisms, though, i.e., one for the deliquescent materials and another for the chromogenic materials in the vicinity where the deliquescent materials migrate. This and other complexities are evident in reviewing the state of the art of humidity indicators. For this reason, a more flexible, sensitive, and reliable approach is needed.

### SUMMARY OF EMBODIMENTS

Embodiments provided herein include those directed to methods for preparing and using a substrate having a deliquescent-containing area for a non-reversible humidity indicator card. Embodiments provided herein also are directed to formulations that are utilized with such cards, as well as the approach of dispensing a composition with a deliquescent material in solution upon a card that can be used as a non-reversible humidity indicator. In some embodiments, a composition is prepared that contains a deliquescent material in solution along with a dye, with or without additional modifiers. The composition is dispensed in a specific area of a humidity indicating card, which then undergoes a drying step. Dispensing occurs by any of a number of available methods, including but not necessarily limited to running the paper card stock along a machine equipped with metered liquid dispensing heads to apply the deliquescing material into one or more defined areas, each being called a “spot.” As desired, numerous cards can be processed on a continuous roll or sheet of active layer, then divided into individual cards using conventional cutting techniques known in the art.

Upon drying, the deliquescent material precipitates and comes out of solution. In this condition, a subsequent exposure to a predetermined humidity causes deliquescence that produces a color migration outside the spot, as in some embodiments the solution contains a dye. In this way, the color migration can be perceived or sensed to indicate that humidity sustained above a predetermined threshold for a sufficient period of time has been reached.

A humidity indicator card according to present embodiments may have a single layer. In some embodiments, this single layer comprises a paper substrate with absorbing properties serving as an active layer. Deliquescent material is dispensed within a spot upon the active layer. As desired, clear markings are used on the card to show the border of the spot. It is within this spot that the deliquescent material should remain, provided the relative humidity surrounding the card stays below a predetermined threshold. As desired, a dye is incorporated with the formulation containing the deliquescent material. The dye provides a specific color feature allowing detection whenever the deliquescent material migrates outside the spot. The migration occurs when the deliquescent material, in precipitate form following drying, absorbs ambient humidity and dissolves, causing the material to bleed beyond the border of the spot.

Once a suitable card is prepared according to the descriptions herein, a solution or composition containing the deliquescent material is dispensed onto the card. In some embodiments, the solution is confined to a spot upon a surface of the card whose border is clearly marked. In some embodiments, the solution is aqueous and comprises a metal halide, additional water, a dye, and at least one modifier, the latter to affect the tendency of the deliquescent material to absorb moisture in the environment.

Optionally, a card according to present embodiments has multiple spots, each with its own border and separate from the other spots. Likewise, the solution of deliquescent materials dispensed within each separate spot is different. In this way, a single card can be used to detect exposure to more than one particular RH. Accordingly, by using one or more modifiers, the same deliquescing material (e.g., an metal halide, denoted herein as “MX”) can form the basis for several solutions to detect RH's along a spectrum. The spectrum can range from a relatively low RH (e.g., 10%) that produces observable deliquescence to much higher thresholds such as 95%. In some embodiments, the solution of deliquescing material requires an exposure for a sufficient period of time (e.g., 24 hours) at a particular RH level before deliquescence occurs that is visibly detectable. Generally, one can consider the amount of time at a particular RH it would take for a particular kind of article to sustain damage, and according to the teachings herein develop formulations that are geared to deliquesce (come back out of solution) under the same conditions of RH sustained over time.

Also, various modes can be selected for dispensing the deliquescent-containing solution upon an active layer of the card. The use of a machine with meter liquid dispensing heads is discussed above. Other non-limiting examples include known spraying methods, printing methods tailored to dispense solutions of deliquescing materials instead of inks, including offset printing, flexographic printing, screen printing, flood coating, and inkjet, as well as the use of daubers for applying liquid solutions to a substrate. Such techniques are known in the field of printing, and can be tailored in a straight-forward manner to the dispensing of solutions containing deliquescent materials.

By whatever dispensing method is chosen, the deliquescent material exists within a spot of the active layer of the card. As the card is dried, the solvent evaporates and the deliquescent material precipitates and remains on the card. Optionally, various modifiers can be incorporated with the formulation to alter the properties of the deliquescent material on the active layer. Then when the material deliquesces on the card during use, there will be an indication provided because the deliquescent material will migrate beyond the border marked on the card. When the solution is colorless it may incorporate a dye, such that the effects of this migration will be visible to the eye, or it could be optically read by a machine.

Having formed the card with an active layer containing a deliquescent material, the card can be placed in a container or other environment where commercial goods might be affected by relative humidity. The thresholds can be selectively determined according to a range of humidity conditions at which deliquescence would result in a return to solution of the precipitated crystals following dispensing and drying. Further advantages will be evident from the descriptions set forth herein.

### BRIEF DESCRIPTION OF THE DRAWINGS

FIG. 1 depicts a humidity indicator card.

### DETAILED DESCRIPTION

Current embodiments are directed to a non-reversible humidity indicator card. Generally, various starting materials are used in manufacturing the formulations, including deliquescent materials that can be processed into solution. The amounts and weight percentages of the materials will vary from formulation to formulation as desired for a particular end use. The deliquescent materials can be dissolved in water before adding to the mixture. Other solvents as known to formulation chemists can be used to dissolve the deliquescent material. In some embodiments, various modifiers and diluents or additional solvents are incorporated into the formulation as noted below.

In an embodiment, the card comprises at least one active layer. In some embodiments, the active layer is a thin, generally planar material of any geometry as desired for the end use, e.g., rectangular. Preferably, the active layer is suitable for receiving inks to show words and other markings on its surface such as for delineating respective borders for one or more spots. As desired, such markings might also contain instructions for use. Suitable materials for the active layer include, without limitation, cellulose- or wood pulp-containing materials such as paper and other non-woven materials (e.g., Tyvek® or similar spunbonded non-woven materials). Depending on the particular application, a multi-layer card is contemplated by these embodiments, which further comprises a backing that the active layer is adhered or affixed to. The backing provides functional improvements such as structural support, protective coating, and a barrier from direct contact for the card and should be suitable for having the active layer affixed to its surface, as by an adhesive or through laminating processes known in the art. The backing need not possess any particular minimum thickness, and may be very thin, e.g., and without intending to limit as to dimension, 5 mm. Such backing can be permeable or impermeable to RH. If permeable, the RH will be absorbed from both sides of the card, but it is not required to absorb RH from both sides of the card.

Alternatively, embodiments include a humidity indicator card comprising only an active layer, such as formed from paper. The active layer of the card demonstrates absorbability to retain the deliquescent-containing solution within the material, as by retention within a cellulose matrix for pulp-containing materials. Generally, a paper formed from cellulose is a suitable material for the active layer sufficient to allow the deliquescent material to absorb into the cellulose matrix. A specific, albeit non-limiting example of such a material is blotting paper that conforms to UU-P-63, also referenced with federal logistics item name code 04784. This is an absorbent, porous, spongy paper made from mixtures of cotton fiber and wood pulp. Other suitable materials for the active layer, again without limitation, would include other woven or non-woven materials having absorbent or adsorbent properties as known in the art.

Upon an active layer of a card, a solution containing the deliquescent material is dispensed. Various ways of dispensing exist, and the scope of embodiments is not limited based on a particular mode of dispensing. In general, the solution with deliquescent material is dispensed so it remains within the particular spot on the active layer of the card. Consequently, if the material deliquesces during use, there will be an indication provided because the deliquescent material will migrate beyond the markings defining the spot. Incorporating a dye in the solution makes the indication visual when the deliquesced solution is colorless.

Accordingly, deliquescent materials are processed into solution and then dispensed upon a surface of the card, and more specifically onto an active layer of the card. In some embodiments, the deliquescent-containing solution is applied within the spot on the surface of the active layer. When dispensed, the deliquescent materials are in solution. Subsequent to dispensing, the active layer(s) is dried so that a substantial amount of the liquid (aqueous or volatile organic) content of the solution is evaporated. Drying can occur through any number of modes, such as but not limited to placement in an oven or direct exposure to hot forced air with a dryer. The temperature of the oven or forced air will depend on the type of liquid solvent used, and can be easily determined with reference to the particular liquids making up the deliquescent-containing solutions.

Upon sufficient drying, the deliquescent material precipitates from solution and remains in the spot where it was dispensed as a solution. The deliquescent material is thus capable of deliquescing at a predetermined humidity according to the particular formulation that is dispensed onto the card. For example, deliquescent materials formed from metal halides have a crystalline structure that will dissolve again in the presence of sufficient humidity within a container, if the humidity remains above a threshold RH for some minimum period of time. Other kinds of deliquescent materials, including those listed in the Background section, can be used within the scope of these embodiments.

After the solution is dispensed onto the card and dried, the card is ready to be used by placing it into a container where it detects the occurrence of relative humidity above a threshold. Some commercial goods that are unaffected by relative humidity below 50%, for example, could be ruined if the relative humidity is sustained above 80% for a predetermined period of time. Conversely, some commercial goods are so sensitive that exposure to 30%, 20%, or even 10% relative humidity is sufficient to cause major damage and loss, or to require mitigation such as having to re-bake a semiconductor. Accordingly, a range of solutions with deliquescent materials can be formulated to provide indications across a wide spectrum of possible humidity conditions in a container or storage.

In view of the teachings contained herein, the following exemplary compositions are suitable for use. Such compositions are dispensed onto a card while the deliquescent materials are in solution, then dried to bring the deliquescent materials out of solution so the card can be used in a container. The example formulations are not limiting, but rather are meant to illustrate how modifiers can be used to further increase the flexibility of the current approach.

### Example Formulations (A1-A3)

In some embodiments, besides water or other known solvents which may be selected, additional modifiers are mixed with the solution, such as without limitation a hydrophilic modifier or a modifier with hydrophobic functionality. Such modifiers change the behavior of the deliquescent materials. For example, a hydrophilic modifier increases the tendency to attract and hold ambient moisture around the deliquescent material, which is in precipitate form after drying. On the other hand, modifiers with hydrophobic functionality have more tendency to repel moisture. Glycerin could be used and serves as one of many suitable examples as a hydrophilic modifier with are known in the art, according to present embodiments. Octylphenoxypolyethoxyethanol could be used and serves as one of many suitable examples as a hydrophobic modifier which are known in the art, according to present embodiments.

The following example formulations are not meant as limiting, but rather illustrative of the flexible approach available from practicing the present embodiments. The approach herein allows a particular deliquescing material and solvent to produce multiple different solutions that deliquesce along a range of RHs. In this way, when different solutions are dispensed on a card as disclosed herein, a single card can be used to more precisely determine the RH in the container.

A1.

| Component | Weight (%) |
|---|---|
| MX | 44% |
| Water | 44% |
| Dye | .9% |
| Hydrophilic Modifier | 11.1% |
| Total: | 100% |

A2.

| Component | Weight (%) |
|---|---|
| MX | 44% |
| Water | 44% |
| Dye | .9% |
| Hydrophobic Modifier | 11.1% |
| Total: | 100% |

A.3

| Component | Weight (%) |
|---|---|
| MX | 49% |
| Water | 50% |
| Dye | 1% |
| Total: | 100% |

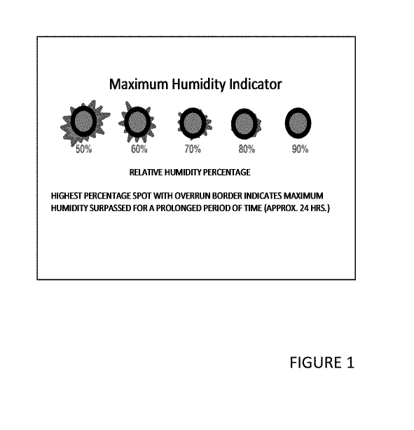

As a non-limiting illustration, the humidity indicator card illustrated in FIG. 1 shows that a RH above 60% was reached, but relative humidity above 70% was either not reached or was not sustained for sufficiently long to cause the deliquescent material to dissolve and bleed beyond the border of the spot.

It will be appreciated that the use of solutions having different modifiers, or no modifiers, allows a single card to present a range of sensitivities to RH inside a container. To illustrate with the above examples, each contains at least a water solvent, MX or a salt that is hydrophilic and soluble in water, and a dye. The above non-limiting examples are identified as A1 (hydrophilic modifier), A2 (hydrophobic modifier), and A3 (no modifier). If the three were placed at distinct spots on a single card, that card can be used to detect RH conditions in a container along a range of possible RHs. For example, A1 (with a hydrophilic modifier) would deliquesce at a lower RH than the other two because hydrophilic compounds have greater tendency to absorb moisture from the air.

In other words, the tendency of a hydrophilic modifier to attract moisture from the surrounding environment means a solution with this modifier requires less RH to produce deliquescence than a solution which is identical except that it lacks this modifier. By comparison, the absence of a hydrophilic modifier, A3 (no modifier) would deliquesce at a higher RH than A1. However, compositions with added hydrophobic or amphiphilic modifiers, such as but not limited to A2, would tend to deliquesce at even higher RHs because of non-polar functional groups. In other words, having a modifier with hydrophobic functionality tends to repel moisture from the surrounding environment, as compared to a solution with a hydrophilic modifier, or no modifier. Thus, a solution with a hydrophobic modifier requires a higher RH to produce deliquescence than a solution which is identical except it lacks this modifier.

Further deliquescent at a particular spot on a card can be controlled not only by selection of modifier, but by the amount of modifier used. Thus, although Examples A1-A3 all list a specific percentage, for illustrative purposes only, the scope of present embodiments would encompass a range of possible weight percentages. Accordingly, changing Example A1 by reducing the hydrophilic modifier to 35% would reduce the RH at which deliquescence occurs compared to A1. Likewise, raising the hydrophilic modifier to 55% would increase the RH at which deliquescence occurs compared to A1. Moreover, changing Example A2 by reducing the hydrophobic modifier to 35% would increase the RH at which deliquescence occurs compared to A2. Likewise, changing Example A2 by raising the hydrophobic modifier to 55% would reduce the RH at which deliquescence occurs compared to A2. In this respect, modifier content can be chosen outside of the ranges set forth or suggested in this paragraph, without departing from the scope of present embodiments.

Accordingly, based on the teachings provided herein, a wide array of compositions could be formed with deliquescent materials in solution for ready dispensing based on the teachings herein. In some embodiments, an aqueous solution of metal halide is mixed with additional water, a dye, with the dye facilitating visual detection. Alternative forms of detection, such as an optical reader or fluorescent dyes, are likely more expensive, but would be within the same kinds of operating principles described herein.

In general, the starting materials for these compositions are mixed in any order, and at a suitable temperature and level of agitation sufficient to place the deliquescent materials in solution, and the compositions are expected to be applied to the card while the deliquescent materials are still in solution. Described herein are a number of exemplary (i.e., non-limiting) deliquescent-containing solutions and formulations. These illustrate the wide range of embodiments for processing deliquescent materials into a solution, which is then dispensed onto an active layer to form a humidity indicator card. Also described are various modes for applying the formulations and preparing a card that contains these deliquescing materials.

It will be understood that the embodiments described herein are not limited in their application to the details of the teachings and descriptions set forth, or as illustrated in the accompanying figures. Rather, it will be understood that the present embodiments and alternatives, as described and claimed herein, are capable of being practiced or carried out in various ways. Also, it is to be understood that words and phrases used herein are for the purpose of description and should not be regarded as limiting. The use herein of such words and phrases as “including,” “such as,” “comprising,” “e.g.,” “containing,” or “having” and variations of those words is meant to encompass the items listed thereafter, and equivalents of those, as well as additional items.

Accordingly, the foregoing descriptions of embodiments and alternatives are meant to illustrate, rather than to serve as limits on the scope of what has been disclosed herein. The descriptions herein are not meant to limit the understanding of the embodiments to the precise forms disclosed. It will be understood by those having ordinary skill in the art that modifications and variations of these embodiments are reasonably possible in light of the above teachings and descriptions.

1. A method for detecting humidity in an environment, comprising: preparing a composition that contains a deliquescent material in solution; and dispensing the composition within a spot upon an active layer of a card; wherein drying the composition after it is dispensed causes the deliquescent material to precipitate, such that upon subsequent exposure to a predetermined humidity the deliquescent material deliquesces and migrates upon the active layer.

2. The method of claim 1, wherein preparing a composition that contains a deliquescent material in solution comprises adding a modifier to the composition.

3. The method of claim 1, wherein as the deliquescent material migrates upon the active layer, a change occurs outside the spot that can be detected.

4. The method of claim 3, wherein preparing a composition that contains a deliquescent material in solution comprises adding a dye to the composition, such that the change outside the spot is a color change brought about by the dye.

5. A humidity indicator card, comprising: a substrate comprising an active layer; a spot on the substrate comprising a precipitate of deliquescent material; wherein the spot is defined by visual markings forming a border, and wherein exposure of the card to relative humidity above a predetermined level causes the precipitate to deliquesce and migrate beyond the border in an observable manner.
